(19) United States
(12) Patent Application Publication
(10) Pub. No.: US 2005/0058978 A1
(43) Pub. Date: Mar. 17, 2005

(54) Individualized learning system

(76) Inventor: Francis A. Benevento II, Palm Beach, FL (US)

Correspondence Address: supervisor patent prosecution services;PIPER RUDNICK LLP., 1200 NINETEENTH STREET N.W., WASHINGTON, DC, 20036-2412, US

(21) Appl. No.: 10/661,046

(22) Filed: Sep. 12, 2003

(51) Int. Cl. G09B 7/00; G09B 3/00

(52) U.S. Cl. 434/362

(57) ABSTRACT

The present invention is directed to a learning system that enables a user to continually build a personalized store of knowledge. The learning system may utilize a portable PC, for example, a laptop, tablet PC, or handheld device, on which a user develops a personalized education profile that includes documents (e.g., books, articles, homework) and modifications (e.g., notes, links, sketches) to the documents. The modifications are separately stored in a storage medium of the portable PC so they may be separately categorized, searched, and retrieved. Personalized summaries of documents and modifications may be generated based on the categorization of such documents and modifications. The personalized summaries are particularly useful when a user desires to review the subject matter taught by the documents and modifications.

### BACKGROUND OF THE INVENTION

1. Field of the Invention

The present invention is directed to an individualized learning system and, more particularly, to an individualized learning system that enables a user to continually build a personalized store of knowledge. The learning system may utilize a portable PC, for example, a laptop, tablet PC, or handheld device, on which a user develops a personalized education profile that includes documents (e.g., books, articles, homework) and modifications (e.g., notes, links, sketches) to the documents. The modifications are separately stored in a storage medium of the portable PC so they may be separately categorized, searched, and retrieved. Personalized summaries of documents and modifications may be generated based on the categorization of such documents and modifications.

2. Description of the Related Art

American education is confronted with a number of challenges evidenced by an increase in classroom costs, low test scores, classroom diversity, learning differences, and disabilities. Educators have attempted to meet these challenges by extending the hours in a school day, reducing the number of available extra-curricular activities, instituting school voucher programs, providing English as a Second Language (“ESL”) programs, and providing on-line courses. Even with all of these efforts it appears that none of them is directed to the particular needs of each individual student. That is, none of the improvements take into account the unique learning experiences of each student. Furthermore, none of the improvements build on the learning experiences of former students for the benefit of subsequent students.

With the ready accessibility of personal computers and, in particular, portable PCs such as laptops and tablet PCs, it has become possible now more than ever for students to reap the benefits of computer technology of education purposes. This is particularly so in light of the fact that the price for personal computers has dramatically declined over the past several years. Adding to this potential is the steady improvements in portable computing technology such as the recent introduction of MS tablet PCs and improvements in high-speed, low-cost access to information over the Internet.

The improvements in computing technology, reduced cost for such technology, and high-speed, low-cost availability of information should enable students to receive an education that is more particularly directed toward their individual needs, whether their needs are created by unique education interests, social/economic dislocation from the mainstream, physical/mental disability.

To a certain degree, students that presently attend school already have use of computing systems and access to educational materials as part of their every day education experience, however, such use typically only supplements their education and is not an integral part thereof. Consequently, the students are not able to take full advantage of the technological improvements.

A learning system is needed that accounts for the personal learning differences, habits, methods, and experiences of each student. Further, a learning system is needed that takes full advantage of the personal learning experiences of educators/former students for the benefit of subsequent students. Furthermore, a learning system is needed that takes full advantage of the potential educational benefits of new technologies and access to educational material.

### SUMMARY OF THE INVENTION

The invention provides an individualized learning method, including storing a document in a storage medium of a device; displaying the document; generating a modification to the displayed document created by a user of the device, wherein the modification is displayed to the user as an integral part of the document; storing the modification separate from the document in the storage medium so that the modification can be separately categorized, searched, and retrieved; and correlating the document and the modification.

One aspect of the invention provides an individualized learning method wherein the device is one of a personal computer, a laptop computer, a tablet PC, and a PDA.

Moreover, such an embodiment provides an individualized learning method wherein the document is selected from materials including textbooks, historical, literary and scientific sources, both primary and secondary, magazines, newspapers, homework, notes, previous tests, projects, assignments, presentations, formulae, compounds, third party commentary, pictures, diagrams, sketches, reference materials, whether audio or video, digital, printed, or hand written.

Another aspect of the individualized learning method comprises a modification in terms of at least one of a note, a highlighted text, a highlighted picture, a highlighted diagram, a specific category of notes, a specific category of highlights, a link to one or more definitions, formulae in notes, proofs explored in notes, personal drawn pictures created in notes, and personal drawn diagrams created in notes, audio notes, and video notes.

Another embodiment of the individualized learning method comprises categorizing the document wherein said categorizing of the document is performed in one of: an automatic mode in which the document is automatically categorized, and a manual mode in which data is received from a user that identifies a category that the document is correlated with.

Another embodiment further comprises categorizing a modification wherein said categorizing of the modification is performed in one of: an automatic mode in which the modification is automatically categorized, and a manual mode in which data is received from a user that identifies a category that the modification is correlated with.

A more specific aspect of the individualized learning method provides that storage medium includes a plurality of documents and a plurality of modifications stored thereon.

An individualized learning method according to the to the invention further comprises generating a personalized summary of an experience based on the categorization of one or more types of modifications made to the documents; for example, the modification can be a note, wherein the note is one of a margin note, pointer note, and interlinear note.

An individualized learning method according to the invention provides the experience including education experience gained from activities including a course of study, a course learning in a class, past tests, teacher/tutor critiques, previous research papers, essays, class notes, class assignments, research notes, class materials, instructor distributions, and/or other learning means a formal and/or an informal nature, digital or otherwise.

More particularly, the individualized learning method of the invention provides that the documents are selected from the group comprising books, reference materials, articles, pictures, sketches, audio, and video.

An individualized learning method of the invention further comprises linking a modification to a resource.

An individualized learning method arranges a resource selected from language dictionaries, thesauri, writing style references, encyclopedias, famous quotation references, tables of absolute data, and dynamic formulas.

Such an individualized learning method provides that the resources include an external resource.

One embodiment of the individualized learning method utilizes is a text document. An individualized learning method of this invention further comprises receiving a second modification to a second document, wherein the second modification is made to the second document by another user on another device.

The method further comprises correlating a third document, identical to the second document, with the second modification, and simultaneously displaying the third document and the second modification, wherein the second modification is displayed as an integral part of the third document.

Another aspect of the individualized learning method further comprises receiving a personalized summary of an experience developed by another user on another device, wherein the experience includes education experience gained from activities including a course of study, a course learning in a class, and/or other learning means in a formal and/or an informal nature.

The individualized learning method includes converting the document that is in an audio form into a transformed document that is in a text form.

The individualized learning method includes translating the document in a first language into a document in a second language to produce a translated document, wherein the document in the first language and the document in the second language are in one of an audio form and a text form. Languages include spoken or classical, logic, Boolean, algebraic, calculus, and symbolic.

An individualized learning method further comprising generating an outline of the document based on the modifications made to the document, wherein the outline is generated based on at least one hierarchy of categorized modifications and a modification made to the document.

Another embodiment of the individualized learning method contains the categorized modifications forming a hierarchy in which the categorized modifications are organized in a nested, summarized, or filtered form.

The individualized learning method further comprises generating a review of the document based on modifications made to the document, wherein the review includes test questions.

Another embodiment of the individualized learning system provides means for storing a document in a storage medium of a device; means for displaying the document, means for generating a modification to the displayed document created by a user of the device, wherein the modification is displayed to the user as an integral part of the document; means for storing the modification separate from the document in the storage medium so that the modification can be separately categorized, searched, and retrieved; and means for correlating the document and the modification.

In particular, the user can develop personalized summaries of experiences that may be shared with other users, the system with a device comprising a monitor for content display; a memory for storing a plurality of documents, modifications to the documents, categorizations of the documents and the modifications, and personalized summaries; and a processor in communication with the memory, wherein the processor is operative to store a document in the memory of the device; display the document on the display screen of the device; generate a modification to the displayed document created by a user of the device, wherein the modification is displayed to the user as an integral part of the document; store the modification separate from the document in the storage medium so that the modification can be separately categorized, searched, and retrieved; and correlate the document and the modification.

Another embodiment of the individualized learning system of this invention provides content display including displaying a document, and modification to a document, and a personalized summary.

One method provides an individualized document list over a data network, comprising: storing a plurality of selected documents, excerpts therefrom, and/or commentary thereon, in a storage medium of a device, wherein the plurality of documents relate to one or more experiences of a user; categorizing the plurality of documents based on the one or more experiences; generating a personalized summary of one of the one or more experiences; and transmitting the personalized summary to a device over the data network. Such method may be implemented all or in part by a computer or a person working with a computer.

### BRIEF DESCRIPTION OF THE FIGURES

A more complete appreciation of the invention and the advantages thereof will be more readily apparent by reference to the detailed description of the preferred embodiments when considered in connection with the accompanying figures, wherein:

FIG. 1 is a diagram illustrating an embodiment of the present invention as used in a network of computers;

FIG. 2 is a block diagram of a general purpose computer that may be used in an embodiment of the invention;

FIG. 3(a) is a block diagram illustrating the interrelationship of components used in an embodiment of the present invention;

FIG. 3(b) shows an exemplary display of a document with various associated modifications according to at least one embodiment of the present invention;

FIG. 3(c) shows an exemplary outline generated based on categorized modifications according to an embodiment of the present invention;

FIG. 3(d) shows two exemplary multiple-choice test questions generated based on categorized modifications according to an embodiment of the present invention;

FIG. 4 is a flow diagram showing an embodiment of a method of the present invention;

FIG. 5 is a flow diagram showing an embodiment of a method of the present invention; and

FIG. 6 is a flow diagram, extending from FIG. 5, showing an embodiment of a method of the present invention.

In the figures, off-page references are used to refer the reader to figures that continue on another drawing page. The references include two parts: an off-page reference letter and a figure number in which the figure continues or from which the figure is continued. An example of an off-page reference is “A/6”, where “A” is the off-page reference letter and “6” is the drawing page on which the figure continues or from which the figure is continued. Furthermore, all like item numbers found in the different figures refer to like items.

### DETAILED DESCRIPTION OF THE INVENTION

The present disclosure provides various embodiments for an individualized learning system. The system accounts for the personal learning habits, methods, and experiences of individual students. In addition, the system enables a student to more thoroughly comprehend and retain knowledge learned during an education experience. Further, the system enables a student to develop a personalized, ever-expanding, and metamorphosizing store of information. Furthermore, the system allows a student to take advantage of the personal learning experiences of others.

An “education experience” or learning experience is broadly defined herein as a course of study, course, class, or self-study experience, all of which may be of a formal or informal nature. Examples of educational experiences provided on a formal basis include, but are not limited to, a course of study in engineering technology, a course in organic chemistry, and single class covering a particular historical event (e.g., U.S. 1993 experience in Mogadishu, Somalia). Examples of educational experiences provided on an informal basis include, but are not limited to, a study of international financial transactions, a study of disability management within the U.S. healthcare system, a study of a particular historical event. From the above, it is apparent that an educational experience may include the use of a single document or a broad array of documents that may be “modified” by a student as the student proceeds through the experience. These documents and modifications can be used to form a personalized summary of the educational experience that may be used by the student or other students as disclosed herein.

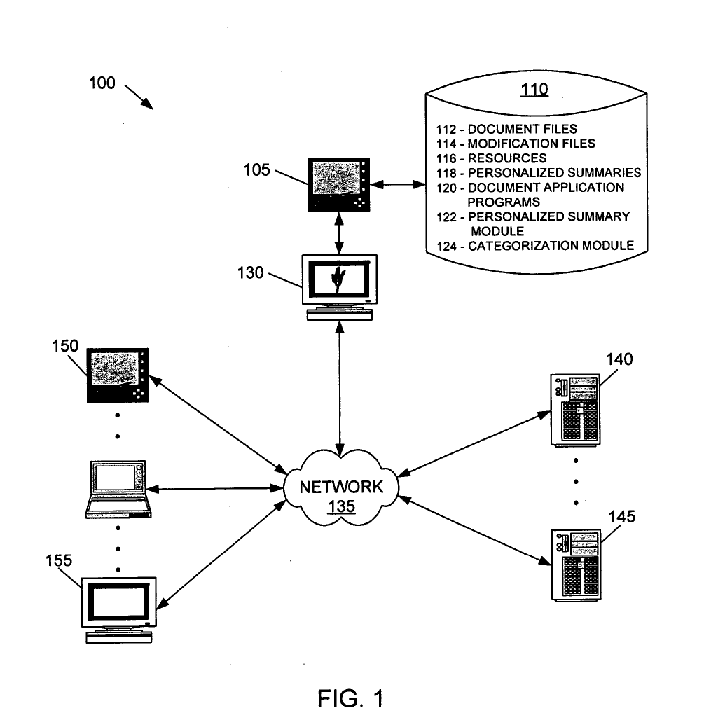

FIG. 1 is a diagram illustrating an embodiment of the present invention 105 as used in a network of computers 100. The illustrated embodiment shows a tablet PC 105 having a storage medium 110. The storage medium 110 may be of any type well know in the art including, for example, a floppy disc, optical disc, DVD, CD-ROM, magnetic optical disc, RAM, EPROM, EEPROM, magnetic or optical card, or any other type of storage media suitable for storing electronic instructions/data. The storage medium 110 may contain various files, resources, modules, and application programs for implementing the present invention, for example, document files 112, modification files 114 (collectively referred to herein as the personal profile of the user), resources 116, personalized summaries 118, document application programs 120, a personalized summary module 122, and a categorization module 124. The stored files, resources, etc., are described in more detail herein below. It will become apparent from the disclosure that other types of computers (e.g., standard personal computers and laptop computers) can be used instead of a tablet PC. Though, tablet PCs have certain advantages over other types of computers that make them particularly suited for use in this invention.

More particularly, those skilled in the art will appreciate that tablet PCs combine the simplicity of paper with the power of the PC; combine the rich features of a notebook with the simplicity of a pen; offer a more natural form of computing; and have an adaptable and more ergonomic form factor. These aspects of tablet PCs have only recently become available due to significant improvements in handwriting recognition, CPUs (lower power, higher performance), LCDs (lower power, higher resolution), batteries (lower weight, higher capacity), digitizers (lower power, higher performance), memory, and wireless network technologies.

Those skilled in the art will appreciate that most students, young adults, and business people spend a great deal of time away from their schools, homes and workspaces, respectively, where they would normally have access to a personal computer. Although many will carry a personal digital assistant (“PDA”), most will not carry a laptop computer wherever they go. Based on the theory that tablet PCs are the systems that users on the move will want to use as their preferred computer system because of their convenience and flexibility, Microsoft introduced a new tablet PC initiative that includes three parts: (1) a new, full-scale version of Windows called “Windows XP Tablet Edition”; (2) a Tablet PC Hardware Requirements specification aimed at original equipment manufacturers (“OEMs”) who want to build tablet PCs; and (3) a set of software development tools (“APIs”) aimed at independent software vendors (“ISVs”) who want to build pen-centric applications for tablet PCs. Notable hardware manufacturers that are supporting this new initiative include Acer, Compaq, Fujitsu, NEC, Tatung, Toshiba, ViewSonic, Gateway, and PAD Products.

Tablet PCs come in different shapes and sizes: traditional notebooks with pen overlays; convertibles, such as the Acer product (in which the screen swivels 180 deg. and folds down on top of the keyboard); desktop PCs with detachable LCD screens that can become standalone tablets; and wireless portfolio tablets that can be connected to a keyboard (e.g., Gateway's Tablet PC includes an integrated wireless IEEE 802.11b MiniPCI card for accessing wireless LANS up to 300 feet from any access port).

In the present invention there is no requirement to use a particular computing device (in fact, though not preferable, a user may decide to implement the present invention utilizing a desktop PC). Due to their inherent advantages, however, portable devices, such as tablet PCs and notebooks, have a number of advantages over other types of computing devices. Between these two devices there are a number of factors that may be considered for determining which is preferred for the user including, for example: (a) whether the user enters data while standing (e.g., amateur astronomers are often standing while entering data); (b) whether the user enters data while walking around (e.g., bird watchers often search the woods for bird species); (c) whether the user prefers to enter data using a pen (e.g., students often find taking notes during class quicker and more convenient when using a pen); (d) the type of data that is being entered (e.g., notes entered in the “margin” of an electronic book are more easily entered using a pen, sketches of art or designs is more easily accomplished using a pen). Generally, although a user entirely involved in corporate-based work may lean toward using a notebook (e.g., for menu driven, point and click applications), a person who uses a portable computer for his/her individualized life's learning experiences (e.g., grade school, high school, collage, graduate and post graduate work, and hobbies such as reading, letter writing, topical studies, astronomy, bird watching, drawing, etc.) may lean toward using a tablet PC. For the purpose of this invention, no preference is made between the different types of computing devices. It is noted, however, that the type of device utilized will depend in large part on the individual user's personal preference based on how he/she intends to incorporate the invention into his/her learning experience.

The system may make use of wireless Internet access. Public wireless networks are proliferating. Such networks allow people to wonder from place to place with their portable PCs and stay continually connected to the Internet. The wireless standard Wi-Fi, or wireless fidelity, is the umbrella name for a collection of related wireless technologies made under an industry standard that allows hardware companies to create wireless products to communicate with each other. Currently, only a small number of libraries, airports and coffeehouses offer access to such networks, which are known as hot spots, but telecoms and technology companies are planning to build thousands more in the years ahead. Many colleges have already implemented Wi-Fi technology, further enhancing the implementation value of the present invention. For example, Dartmouth College has more than 500 Wi-Fi antennas that cover roughly 200 acres of the campus.

Referring again to FIG. 1, the tablet PC 105 may be in communication with a personal computer 130 to provide, for example, backup storage, printer capability, and access to a network 135 utilizing any of the methods well known in the art (e.g., dial-up terminal, cable modem, digital-subscriber line (“DSL”), virtual private network (“VPN”)). Alternatively, the tablet PC 105 may be in direct communication with the network 135. Docking stations are available for most tablet PCs that enable them to readily connect to peripherals like an external monitor, printer or optical drive, and are also typically equipped to connect the tablet PC to a network. The network 135 may be, for example, an intranet or the Internet.

The tablet PC 105 may be in communication with server computers 140-145 (representing one or more servers) via network 135 that provide access to document files, modification files, resources, other user's personalized summaries, etc. The tablet PC 105 may be in communication with client computers 150-155 (representing one or more client computers) via network 135 that provide access to document files, modification files, resources, personalized summaries, etc. Of course, client computers 150-155 may also be making use of embodiments of the present invention. Therefore, for example, the user of tablet PC 105 can create personalized summaries of various educational experiences (e.g., a course of study, a class, non-traditional educational experiences) and make them available to other users via their client computers 150-155. Likewise, the users of client computers 150-155 can create personalized summaries of their educational experiences and make them available to other users.

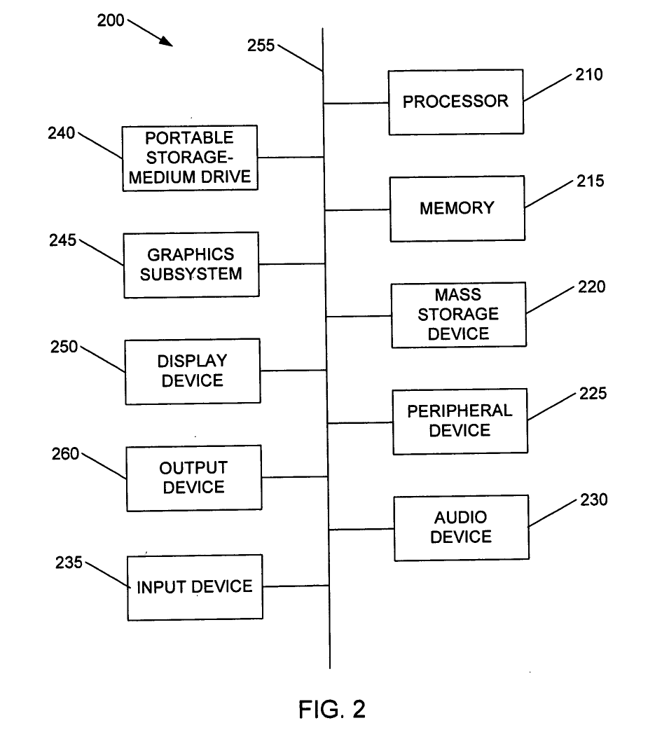

The document files, modification files, resources, personalized summaries, etc. can be made available, for example, through a user's personal web site or via a broker that specializes in offering such educational data through the broker's web site. The tablet PC 105, client computers 150-155, and servers 140-145 may be configured as the general purpose computer 200 shown in FIG. 2.

FIG. 2 illustrates a high-level block diagram of a general purpose computer 200 which may be used to implement the present invention. The general purpose computer 200 may depict the general configuration of the tablet PC 105, client computers 150-155, and servers 140-145 shown in FIG. 1. The general purpose computer 200 includes a processor 210 and memory 215. Memory 215 stores instructions and data for execution by processor 210. If the system of the present invention is wholly or partially implemented in software, including computer instructions, memory 215 stores the executable code when in operation. Memory 215 may include banks of dynamic random access memory (DRAM) as well as high speed cache memory.

The computer system 200 may further include one or more mass storage devices 220, peripheral devices 225, audio devices 230, input devices 235, portable storage-medium drives 240, graphics subsystems 245, and display devices 250. For purposes of simplicity, the components shown in FIG. 2 are depicted as being connected via a single bus 255, however, the components may be connected through a network. For example, processor 210 and memory 215 may be connected via a local microprocessor bus, and the mass storage device 220, peripheral device 225, portable storage medium drive 240, and graphics subsystem 245 may be connected via one or more input/output (I/O) buses. Mass storage device 220, which is typically implemented with a magnetic disk drive or an optical disk drive, may be a non-volatile storage device for storing data and instructions for use by processor 210. The mass storage device 220 includes the storage medium of embodiments of the present invention, and the server storage medium and client storage medium in alternative embodiments.

Portable storage medium drive 240 operates in conjunction with a portable non-volatile storage medium, such as a floppy disk, or other computer-readable medium, to input and output data and code to and from the computer system 200. In one embodiment, the method of the present invention that is implemented using computer instructions is stored on such a portable medium, and is input to the computer system 200 via the portable storage medium drive 240. Peripheral device 225 may include any type of computer support device, such as an input/output (I/O) interface, to add additional functionality to the computer system. For example, peripheral device 225 may include a network interface card for interfacing computer system 200 to a network, a modem, and the like. As a further example, tablet PC 105 may include a Wi-Fi radio device, either built in or embedded in a PCMCIA card, for communicating with client computer 130 that includes an access point or gateway to serve as the base station for a Wi-Fi network.

Input device 235 provides a portion of a user interface. Input device 235 may include: an alpha-numeric keypad for inputting alpha-numeric and other key information; a pointing device, such as a mouse, a trackball, stylus or cursor direction keys; or a digitizer pen for entering text on the screen of a tablet PC. In order to display textual and graphical information, the computer 200 includes graphics subsystem 245 and a display device 250. Display device 250 may include a cathode ray tube (“CRT”) display, liquid crystal display (“LCD”), plasma display, or other suitable display devices. The display device 250 of a pen-enabled computer (e.g., a tablet PC) is unique in that they incorporate a sensor grid that usually sits underneath an LCD. The sensor grid senses the presence of a digitizer pen and responds to that presence with the equivalent of a left mouse click at the particular X and Y coordinates where the presence is sensed.

Graphics subsystem 245 receives textual and graphical information and processes the information for output to display device 250. The method of the present invention may be directly and practically implemented through the use of the display device 250. In one embodiment, an audio device 230 includes a sound card that receives audio signals from a microphone that may be found in a peripheral device 225. In another embodiment, the audio device 230 may be a processor, such as processor 210, that processes sound. Additionally, computer system 200 includes output device 260. Examples of suitable output devices 260 include speakers, printers, and the like.

The devices contained in the computer system 200 are those typically found in a general purpose computer and it is intended that the computer system 200 may comprise a broad category of such computer components that are well known in the art. The computer system 200 illustrates one platform which can be used for implementing the method of the present invention. Numerous other platforms may also suffice, such as Macintosh-based platforms available from Apple Computer, Inc. (Cupertino, Calif.), platforms with different bus configurations, networked platforms, multi-processor platforms, other personal computers, workstations, mainframes, navigation systems, and the like.

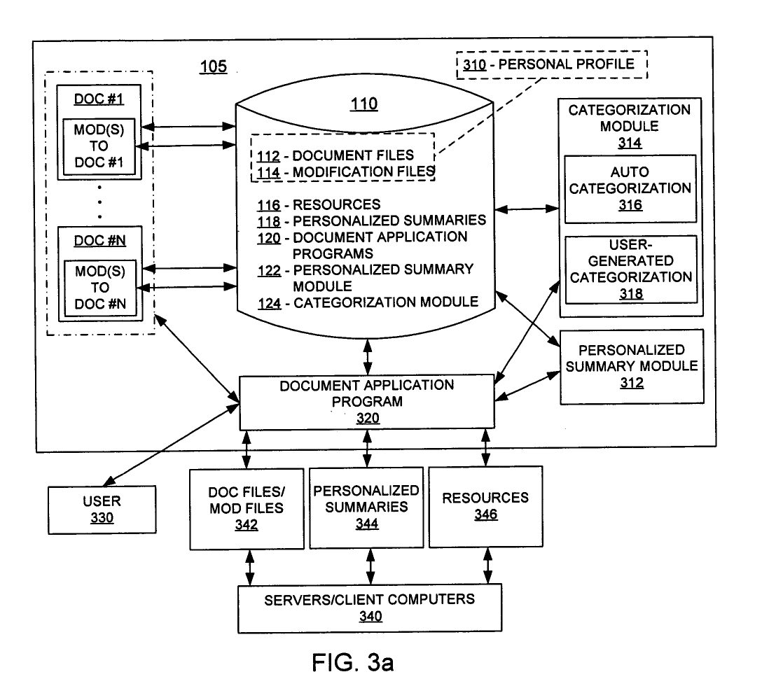

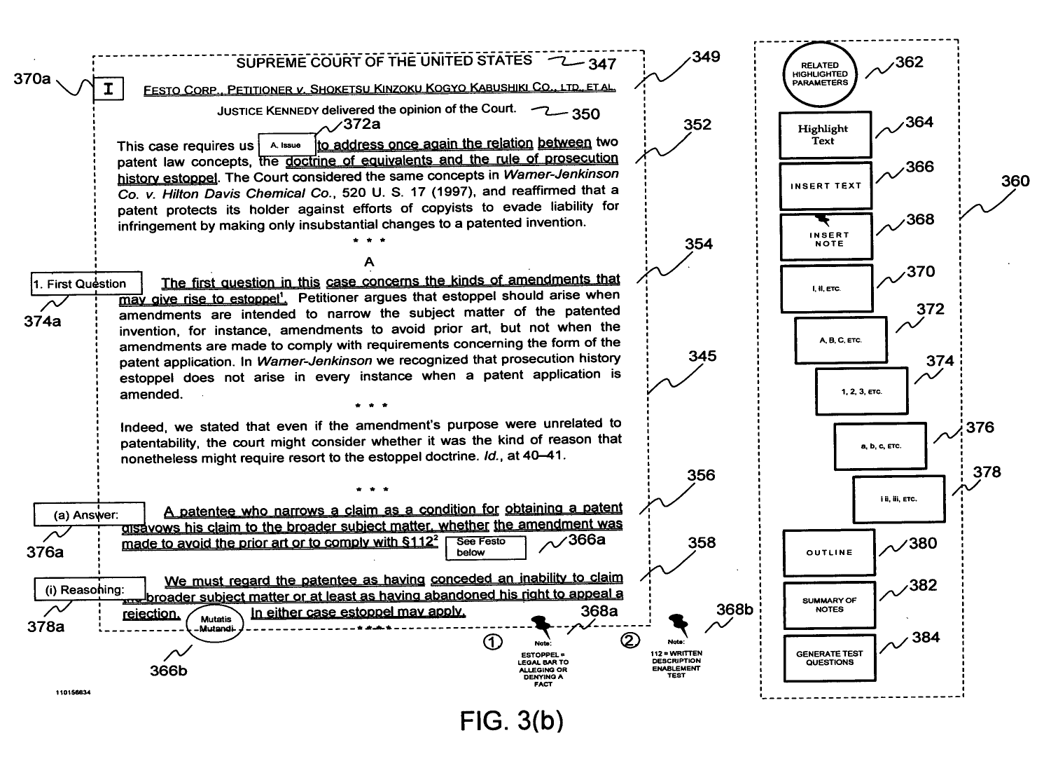

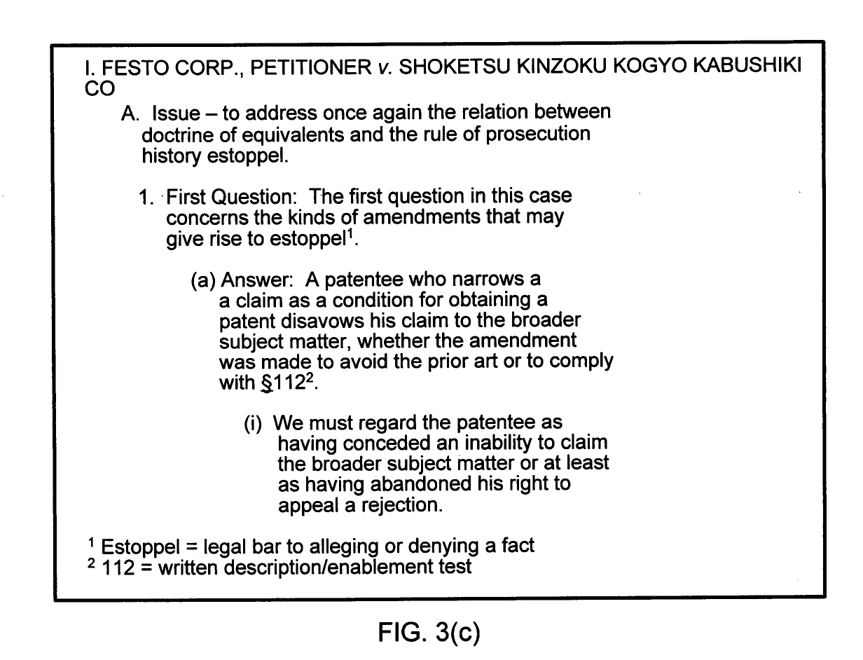

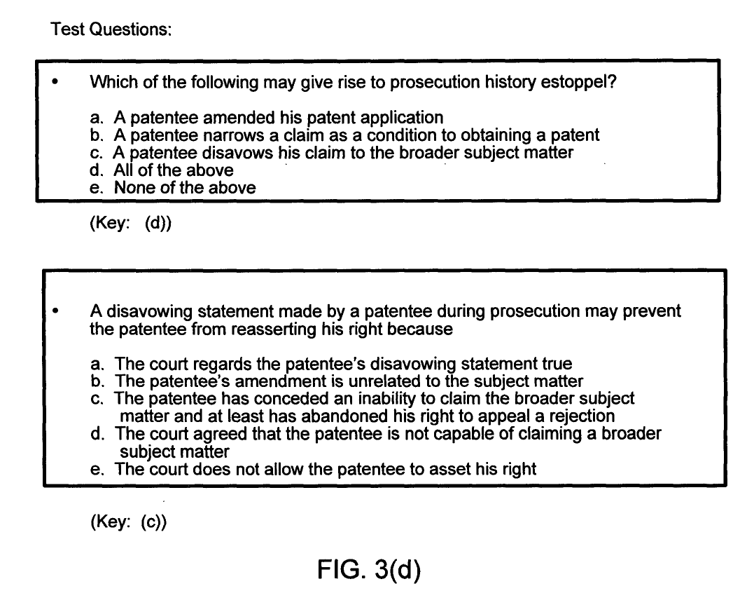

FIG. 3(a) is a block diagram illustrating an embodiment of the present invention, wherein a tablet PC 105 is operated by a user 330 and in communication with servers and client computers, collectively referred to as item 340. Tablet PC 105 includes a storage medium 110 on which may be stored document files 112, modification files 114 (collectively referred to herein as the user's personal profile 310), resources 116, personalized summaries 118, document application programs 120, personalized summary module 122, and a categorization module 124.

The user 330 may retrieve a document (e.g., Doc #1) from the document files 112 in storage medium 110 or alternatively from other data sources such as a web site or a remote database. The user 330 may make modifications (e.g., Mod(s) to Doc #1) to the document via, for instance, a document application program 320. For example, the user may load a text document into a text editing program (e.g., Word by Microsoft Corp., Redmond, Wash.), make various modifications to the text document (e.g., add notes, highlight text, add links to resources, add pictures/sketches, add links to audio/video), and store the text document and modifications in the document files 112 and the modification files 114, respectively. Documents and modifications may be stored separately so they may be individually categorized, searched, and retrieved. However, such separately stored information may be correlated so that modifications may be displayed when the document is displayed if the user so desires (e.g., selects an option in the document application program 320 that enables the document and modifications thereto to be coincidently displayed).

Other types of documents may also be displayed and modified. For example, the user may load a CAD drawing document into a drawing editing program (e.g., AutoCAD by Autodesk, Inc., San Rafael, Calif.), make various modifications to the drawing document (e.g., add notes, highlight text, add links to resources, add pictures/sketches, add links to audio/video), and store the drawing document and modifications in the document files 112 and the modification files 114, respectively.

Utilizing a categorization module 314, the user may also categorize the documents and/or modifications automatically 316 or categorize documents and/or modifications using a user-generated categorization module 318. When the user selects to have a document or modification automatically categorized, some predetermined categorization criterion may be utilized. When the user selects to have a document or modification categorized using a user-generated categorization, the user may be required to supply or input criterion. Categories may be based on any number of criterion. Categories for documents may include, for example: the type of document (e.g., textbook, novel, patent case law, article, class notes, homework, class project, audio, video); a characteristic of the document (e.g., mathematical text, historical novel, legal opinion, audio of a class lecture, video of an experiment); a title or label given to the document (e.g., “introduction to trigonometry,” “building of the transcontinental railroad,” “Festo v. Shoketsu”, “video of Dr. Bob's lecture on octahedron molecular structures”). Similarly, categories for modifications may include, for example: the type of modification (e.g., margin note, pointer note, interlinear note, highlighted text, pictures/sketches); a characteristic of the modification (e.g., color-coded note/highlight, layers in a picture/sketch); a title or label given to the modification (e.g., “math proof,” “legal issue”, “personal observation,” “to-do list”).

FIG. 3(b) shows an exemplary display of a document with various associated modifications according to at least one embodiment of the present invention. In the example, a document 345 is a legal opinion on case “Festo Corp. v. Shoketsu Kinzoku Kogyo Kabushiki Co. Ltd.” written by the Supreme Court of the United States. The document 345 may be retrieved as one of the document files stored in the storage medium 110 or may be retrieved from a remote location via some network communication means. The retrieved document 345 may be displayed via a document application program (e.g., Word by Microsoft) on a display device (e.g., 250) on a certain portion of the associated display screen.

An exemplary portion of the document 345 is shown in FIG. 3(b). The illustrated portion corresponds to the beginning page of the opinion case “Festo Corp. v. Shoketsu Kinzoku Kogyo Kabushiki Co. Ltd.”, which includes the source of the opinion (e.g., “The Supreme Court of the United States” 347), the name of the case (e.g., “Festo Corp. v. Shoketsu Kinzoku Kogyo Kabushiki Co. Ltd.” 349), the author of the opinion (e.g., “Justice Kennedy” 350), and body of the opinion comprising a plurality of paragraphs. Individual paragraphs in the body of the document 345 may be recognized as such for operational purposes (e.g., link certain modifications to certain paragraphs). The paragraphs may be grouped into different sectors (e.g., section A of the document as shown in FIG. 3(b)). The document 345 may be displayed with some margins. Such margins may have pre-determined size and such size may also be dynamically adjustable.

Various modifications may be performed with respect to the document 345. For example, some portions of the document may be highlighted, notes may be inserted in the margins, or links may be introduced to point to another document/modification or other sources. Modifications may be effected within the document (e.g., highlight a portion of the document) or in the margins (e.g., notes about a piece of highlighted document may be inserted in the margin near where the highlighted portion is displayed). Other types of modifications such as automatic categorization of modifications may also be performed.

To facilitate modifications, a plurality of buttons 360 through which various modification actions may be activated may also be displayed on the same screen of the display device. This may include buttons for operations to be performed directly on the displayed text (e.g., highlighting text or adding text) and operations that create insertions in the margins, summarization or categorization. Exemplary buttons may include, but not be limited to, buttons corresponding to operations to be performed directly on the displayed document, buttons corresponding to operations to categorize documents/modifications, and buttons corresponding to operations to generate summaries based on certain documents/modifications.

In the illustrated example, buttons corresponding to direct document operations may include, but not be limited to, a “highlight text” button 364 and an “insert text” button 366. An “insert note” button 368 may facilitate the operation of adding a note in margins. To insert a note in the margin of the document 345, the user 330 may simply click on the button 368 which may subsequently pop up an iconic representation of a note page allowing the user 330 to enter the note. In FIG. 3(b), two exemplary inserted notes 368a and 368b are shown. Each note corresponds to a definition associated with some legal term. Text insertion may also be performed by, for example, simply clicking on the button 366 and entering the desired text within the document 345. An illustration of inserted text is shown as 366a and 366b, where 366a is inserted at the end of a paragraph and 366b is inserted in the middle of a paragraph.

In addition, a series of buttons 370, 372, 374, 376, and 378 may be provided to facilitate categorizing documents/modifications. Such categorization capabilities may also be structured or configured so that categorization may be performed in a hierarchical or nested fashion. For instance, the button 370 may represent categorization operation at the highest level. Under this highest level of categorization, the next level of categorization may be facilitated through button 372. Similarly, under this next level of categorization (372), a lower level of categorization may be further facilitated by button 374, etc.

Categorization may be applied to the entire document (e.g., document 345 is a biology book) or to a particular part of the document (e.g., the second portion of the document 345 corresponds to the title of the document). Each category may have multiple instances (e.g., there may be multiple books under the category of “Science”) and each category may further have sub-categories (e.g., category “Science” may include sub-categories such as “Physics”, “Mathematics”, etc.).

Categorization at each level may be named using some labels. For example, in the illustration, categorization at a highest level (370) may be associated with category name “Title” (not shown), and instances of this category may be enumerated using capitalized Roman numerals I, II, III, etc. Under each “Title”, there may be further categorization of “Legal Issue”, and instances of this category may be enumerated using capitalized English letters such as A, B, C, etc. (372). Further down the chain, there may be categories corresponding to “Legal Question” (e.g., relevant legal questions for each legal issue), “Answer” (e.g., answer to each relevant question under each legal issue), and “Reasoning” (e.g., the reasoning based on which an answer is derived for each relevant question under each legal issue), where instances and such categories may be enumerated using Arabic numbers (i.e., 1, 2, 3, etc. at 374), lower case English letters (i.e., a, b, c, etc. at 376), and lower case Roman numerals (i.e., i, ii, iii, etc. at 378).

The name of each category may be defined in a particular application for a specific purpose. For example, the above-described category names may be defined by and be suitable for a user who may be engaged in law (e.g., an attorney or a law student) and may be used to create briefs or outlines of court opinions. Different users may define category names differently. For example, a graduate student in physics may define category names in a similarly structured hierarchy based on research topics. In this case, the highest level of category may correspond to “Research Topic”, followed by “Experiment”, “Observation”, “Test Data”, “Analysis”, and “Conclusion”. As another example, a performing arts student may instead organize his/her category hierarchy according to “Play”, “Scheduled Performance”, and “Role to Play”. Category titles and script may be manually input or pre-defined so as to be automatically inserted when a certain category level is chosen.

Documents or portions of a document may be categorized using such defined categories. For example, as shown in FIG. 3(b), a portion 350 of the document 345 may be categorized as an instance of a title (of a document). To do so, the user 330 may first click on the button 370 to enter into a categorization mode at the level of “Title” category and may then underline the portion 350 to indicate what is to be categorized as a title. When the button 370 is selected, a capital Roman numeral 370a (e.g., “I”) may be automatically generated to label this particular instance of title. Other portions of the document 345 may be similarly categorized. For instance, the button 372 may be clicked to categorize a document portion 352 as a legal issue 372a, which is labeled using an automatically generated label (e.g., “A”). Under this legal issue, a portion 354 of the document 345 may be underlined and categorized as a legal question 374a under the legal issue (e.g., 372a) labeled as the first question. A portion 356 of the document 345 may be underlined and categorized as an answer (376a) to the previous legal question (374a) labeled as (a). Finally, a portion 358 of the document 345 may be underlined and categorized as a reasoning 378a relevant to the answer 376a related to the legal question 374a of the legal issue 372a.

A hierarchy defined based on a set of named categories may create a template through which information from documents and/or modifications may be organized. For a user-defined hierarchy, the user 330 may optionally elect to create an iconic representation of the hierarchy for each activation and access. For instance, a button 380 labeled as “Outline” may be created to represent a hierarchy defined to organize different categories of modifications into a legal outline. To enable different operations associated with an outline, the button 380 may be linked to sub-choices. For instance, when the button 380 is clicked (or selected), a sub-menu may pop up to enable further determination of the operation to be performed on the information organized using this hierarchy. A sub-menu may present different operational choices such as “Create Outline”, “Delete Outline”, and “Save Outline” (not shown). When a particular sub-choice is selected, e.g., “Create Outline”, modifications created in each category under the hierarchy corresponding to “outline” may be automatically organized into a legal outline.

An exemplary outline 390 generated based on the modifications illustrated in FIG. 3(b) is shown in FIG. 3(c). This outline may be created by clicking on the button 380 and selecting sub-choice “Create Outline”. The outline is generated by organizing modifications 370a, 372a, 374a, 376a, and 378a according to the structure of the underlying hierarchy defined by 370, 372, 374, 376, and 378. In the illustrated example outline 390, 370a represents the title of the outline (i.e., the case name of the legal opinion); 372a presents the first issue that the Court addresses in the opinion; 374a presents the first question related to the first legal issue; 376a extracts an answer to the first question of the first issue; 378a refers to a reasoning that the Court used to reach its answer. In addition, the inserted notes, e.g., 368a and 368b, are also included in such generated outline 390. Such generated outline may also be treated as a modification within the meaning described herein.

The user 330 may dynamically define different categorization classes and how different categories may be organized to form higher level of information summarization. Dynamic changes may be made based on the user's needs or the subject matter that the user 330 is dealing with. That is, the user 330 may have different folders, each of which may correspond to different topics and each may have its own pre-defined hierarchies of categories, specific definition of each category, etc. When a particular folder is opened, all the pre-defined hierarchies and the definitions of categories may be accordingly loaded so that the user 330 may be able to operate in each subject matter in an appropriate fashion.

Referring back to FIG. 3(b), other functionalities may be provided by the tablet PC 105 that facilitate, for example, summarization capabilities or automatic test question generation capabilities. Such functionalities may be similarly activated through buttons. For instance, a button 382 may represent the operation of summarizing notes. With this functionality, a range of documents/modifications previously created may be integrated to generate a summary when the button is selected.

Based on documents and modifications (which may have been categorized using the categorization module 314), the user 330 may utilize a personalized summary module 312 to develop personalized summaries based on the categorized documents and modifications. A personalized summary may correspond to a summary of one or more selected categories of documents and/or modifications. The category of documents and/or modifications can be as narrow as the modifications made by a user during his reading of a document (e.g., “margin notes” taken by a user when reading “Undaunted Courage” by Stephen Ambrose)’ or more broad to cover all documents read by a user during his study of a particular subject matter (e.g., a list of books and articles concerning the “Battle of Gettysburg”), and even more broad to cover all subject matter covered by a student during a four-year undergraduate degree program (e.g., all of the books, homework, projects, etc., and modifications to those documents that a student used during a four-year course of study for electrical engineering).

The function of generating a summary may be applied to different types of information. It may be applied to the modifications made to a document. In this case, all the modifications may be organized in a sequence as they are made. Alternatively, the functionality of generating a summary may also be applied to some categorized information or even a hierarchy of categories such as the one shown in FIG. 3(b). In this case, since each modification is categorized (e.g., 374a corresponds to a legal question), a more intelligent summary may be generated. For instance, instead of putting all the highlighted portions of the document 345 together to form a summary, an intelligent summary may place each piece of the highlighted portion under the categorization. For example, utilizing the definitions of each category, a summary having more than simply the highlighted text may be generated: “In Festo (utilizing the fact that the second level of category is an “Issue”) once again the relation . . . The first question . . . give rise to estoppel. The Court reached the answer to the question (category is “Answer”) that a patentee who narrows . . . . The Court reasoned (category is “Reasoning”): we must regard the patentee . . . . In either case estoppel may apply.” Such generated summaries may also be viewed or treated as modifications within the meaning described herein.

Information used to generate a summary may be from a pre-defined scope of information. The scope may be defined according to the nature of the summary to be generated. For instance, it may be defined to include only notes inserted in the margins. The scope may also be constrained within one document, a series of documents that are related according to some classification (e.g., same category), or documents that are linked to the underlying document (e.g., document 345). The system may also be configured so that the user 330 is enabled to adjust the scope when needs change.

Another exemplary functionality corresponds to automatic test question generation. A button, 384, may be provided to activate the capability. The function of generating test questions may be applied to different types of information. It may be applied to a document or the modifications made to a document. The modifications may include outlines and summaries. FIG. 3(d) illustrates exemplary test questions generated based on the outline 390 shown in FIG. 3(c). In this example, test questions are generated in the form of multiple-choice questions. Each of the test questions may include a question, a plurality of choices of answers, and a key to the question.

A test question may be generated based on the content contained in the outline including the name of each category. For example, in the first test question 391, the question itself (392) may be generated based on the first legal question 374a (see FIG. 3(b)), a plurality of choices of answers (393), and a key (394) may be generated based on the answer 376a in the outline 390. Similarly, in the second test question 395, the question itself (396) may be generated based on both the first legal question 374a as well as the reasoning 378a, a plurality of choices of answers (397), and a key (398) may generated based on the reasoning 378a in the outline 390.

The functionalities that enable the user 330 to produce derivative works based on documents/modifications (e.g., define/create outlines, summaries, and test questions) may be performed by a derivative information generation mechanism 322 as depicted in FIG. 3(a). This mechanism may interact with different parties, including the user 330, the storage mechanisms (e.g., 110, 342, 344, 346), the categorization mechanism 314, the document application program 320, and possibly the servers/client computers 340 for, for instance, remote data access.

Through the above described various exemplary functionalities, the user 330 may generate different types of information based on his individualized understanding of the content of various materials. That is, modifications, outlines, summaries, or test questions may be generated based on personal view or perspectives of the written or visual or acoustic materials. Through the means described herein, documents, portions of documents, and modifications made to documents may be efficiently and effectively organized to generate derivative works that reflect individualized learning process, work product, and generation of new thoughts.

The tablet PC 105 may advantageously be in communication with servers and client computers 340 allowing the user 330 to transmit thereto and receive therefrom document files and modification files 342, personalized summaries 344, and resources 346.

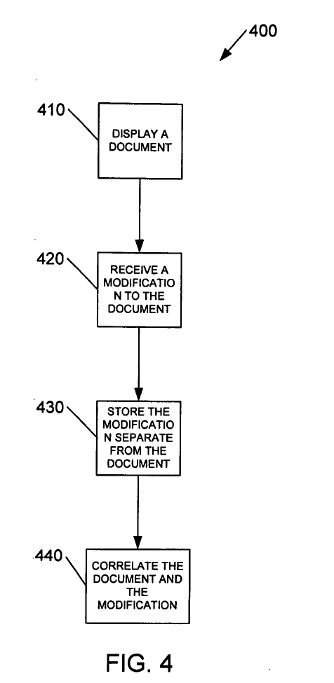

FIG. 4 is a flow diagram 400 showing generally an embodiment of an individualized learning method, which may be implemented by the system described herein above. At step 410, a document such as a book or article is displayed on the monitor of tablet PC 105. At step 420, the user makes modifications to the document such as by adding notes in the margins and highlighting text. At step 430, the document and modifications are stored separately in the storage medium 110 of the tablet PC 105. Storing the document and modifications separately allows the document and modifications to be separately categorized, searched, and retrieved. At step 440, although stored separately, the document and modifications are correlated so that the modifications may be displayed when the document is displayed, if so desired by the user.

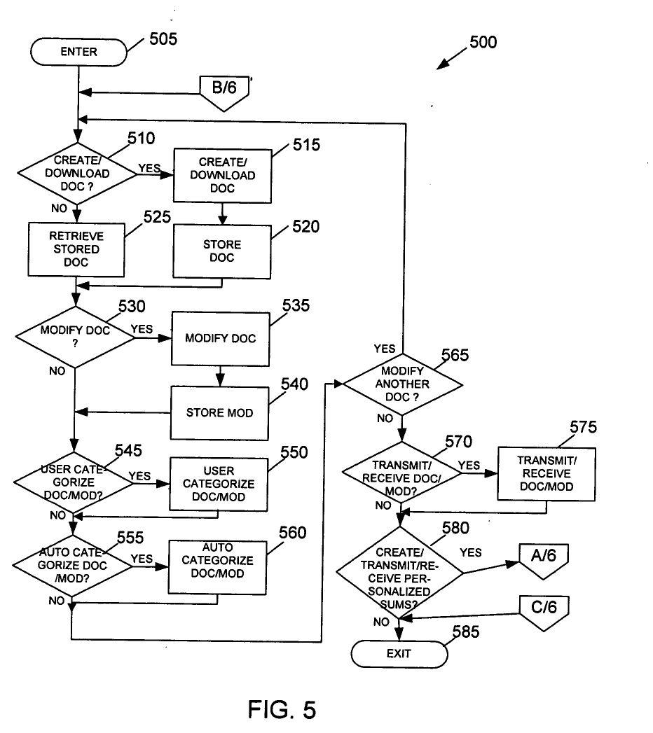

FIG. 5 is a flow diagram showing an embodiment of a method of the present invention. Those of ordinary skill in the art will appreciate that a particularly important aspect of the inventive method is that it enables individuals to build a personalized, ever-expanding, and metamorphosizing store of knowledge based on a user's learning experiences. Furthermore, individuals may share their store of knowledge with others so that others may take advantage of their learning experiences.

The method is carried out utilizing a computer, preferably a portable computer, and more preferably a tablet PC because of their portability, flexibility, and ready integration into an active lifestyle. An exemplary user is a student taking a formal course of study at a university, on the go from class to class, downloading electronic textbooks, making electronic modifications in the textbooks, generating homework papers and projects, and preparing for examinations. Another exemplary user is a person who takes it upon himself to learn a particular subject matter, downloads electronic articles from magazines, makes modifications to the articles, generates written materials, and desires to review his accumulation of materials from time to time to ensure he fully comprehends the subject matter.

At step 505, a user turns on their tablet PC 105 and opens an appropriate document application program 320. At step 510, the user is queried as to whether the user desires to create or download a document. If the user desires to create or download a document, the user may proceed to step 515 and create a document using the document application program 320 or download a document, for example, over the network 135. At step 520, the user stores the document in the storage medium 110 of the device 105 (or computer) and thereafter proceeds to step 530. If, at step 510, the user does not desire to create or download a document, then the user may retrieve a previously stored document from the storage medium 110 at step 525.

At step 530, as the user reviews a document the user has the option to make various modifications to the document. If the user desires to modify the document then the user proceeds to step 535 and makes modifications. The tablet PC 105 may allow for numerous types of modifications, thereby making the modifications particularly useful for future reference, for example, when generating a personalized summary of a course to study for a final examination.

Exemplary modifications, that is, supplementary information, that may be added to the document, include, for example: notes; links; pictures; audio; video; sketches; and highlighted text, pictures, and diagrams. Exemplary notes include: “margin notes” wherein the margin of a document may be stretched to any width to accommodate the notes; “pointer notes” wherein a marker (e.g., a red dot) may be included which, when selected, goes to another screen where notes may be made; and “interlinear notes” wherein the area between lines of text automatically adjusts to accommodate the size of the notes. Exemplary links include: links to various internal resources (e.g., resources located on the storage medium 110 of tablet PC 105) and external resources (e.g., resources located on the storage medium of another computer) such as other documents, language dictionaries, language translators, thesauri, writing handbooks, encyclopedias, familiar quotations, tables of absolute data, and dynamic formulas.

At step 540, the user stores any modifications made to the document in the storage medium 110 and proceeds to step 545. If, at step 530, the user does not desire to modify the document, then the user proceeds directly to step 545 and is queried as to whether the user desires to categorize a document or modification utilizing a user-generated categorization module 318. If the user desires to categorize a document or modification then the user proceeds to step 550, wherein the user utilizes the user-generated categorization module 318 as described above. Thereafter, the user proceeds to step 555. If, at step 545, the user does not desire to categorize a document or a modification using the user-generated categorization module 318 then the user may proceed directly to step 555. At step 555, the user is queried as to whether the user desires to have the system automatically categorize a document or modification utilizing the auto-categorization module 316. If the user desires to utilize the auto-categorization module 316, the user proceeds to step 560 and utilizes the auto-categorization module as described above. Thereafter, the user proceeds to step 565. If, at step 555, the user does not desire to categorize a document or a modification utilizing the auto-categorization module 316, then the user may proceed directly to step 565.

At step 565 the user is queried as to whether the user desires to modify another document. If the user desires to modify another document then the user proceeds to step 510 and proceeds as described herein above. If, at step 565, the user does not desire to modify another document then the user proceeds to step 570, wherein the user is queried as to whether the user desires to transmit or receive a document or modification. If the user desires to transmit or receive a document or modification then the user proceeds to step 575.

In one embodiment of the present invention the user transmits only the modifications made to a document. For example, a first user may make extensive modifications (e.g., notes, links, text highlights) to “The Art of War” by Sun Tzu. The first user may transmit the modifications to a second user who may review the modifications alone, or correlate the modifications with his electronic copy of the book and review the book together with the modifications. In another embodiment of the present invention the first user is a student, and the second user is a teacher that requires the student to provide the modifications so the teacher may grade the student's understanding of the book. In yet another embodiment of the present invention the first user may be a student, the second user may be a teacher, the document may be a final examination for a course, and the modifications may be the student's answers to the final examination. The student would transmit the modifications to the teacher so the teacher may grade the student's understanding of the course.

Once the user has transmitted or received documents or modifications, the user proceeds to step 580. If, at step 570, the user does not desire to transmit or receive a document or modification, then the user may proceed directly to step 580.

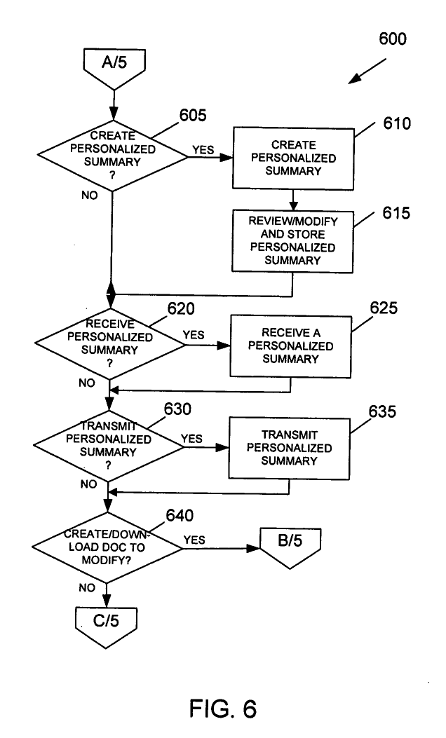

At step 580, the user is queried as to whether the user desires to create, transfer or retrieve personalized summaries. If the user desires to do so then the user proceeds to 605 (FIG. 6). At step 605 the user is queried as to whether the user desires to create a personalized summary utilizing personalized summary module 312. If the user desires to created a personalized summary the user proceeds to step 610 wherein the user proceeds as described above to create a personalized summary of particular documents and/or modifications stored on the tablet PC 105. The personalized summary may be based on categories developed for the documents and/or modifications. As an example, the user may have categorized documents and modifications from a course on electromagnetic fields under the category “EE-352” (the course identifier). In preparation for the final examination the user may create a personalized summary of the course that includes select modifications (e.g., notes, highlighted text, and sketches) to the documents in category “EE-352.” The personalized summary provides an ideal tool for the user to prepare for the final examination in that it brings together all modifications developed by the user over the semester. Once a personalized summary is created the user proceeds to step 615 to review and modify the personalized summary in order to fine-tune the personalized summary so it best suits the user's purpose. Thereafter the user proceeds to step 620. If, at step 605, the user does not desire to create a personalized summary, then the user may proceed directly to step 620.

At step 620, the user is queried as to whether the user desires to retrieve a personalized summary from another user. If the user desires to retrieve a personalized summary then the user proceeds to step 625. At step 625 the user accesses and retrieves one or more personalized summaries.

In one embodiment of the present invention the user logs onto a server via a network 135 on which other users' personalized summaries are stored. The user may then download one or more personalized summaries developed by another user. The web site may be that of a personalized-summary broker that licenses personalized summaries covering various subject matter. In another embodiment of the present invention the user logs onto a university web site and receives one or more personalized summaries of other students that previously took a course that the user is now enrolled. The user utilizes the personalized summaries to better understand the concepts taught in the course and prepare for examinations.

After the user accesses and receives one or more personalized summaries at step 625, the user proceeds to step 630. If, at step 620, the user does not desire to receive personalized summaries, then the user may proceed directly to step 630.

At step 630, the user is queried as to whether the user desires to transmit personalized summaries. If, at step 630, the user desires to transmit personalized summaries, then the user proceeds to step 635 and transmits personalized summaries. Thereafter, the user proceeds to step 640. If, at step 630, the user does not desire to transmit personalized summaries, then the user proceeds directly to step 640. At step 640, the user is queried as to whether the user desires to create and/or download documents to modify. If, at step 640, the user desires to create and/or modify a document, then the user proceeds to step 510 (FIG. 5) and proceeds as described above. If the user does not desire to create and/or modify a document, then the user proceeds to step 585 (FIG. 5) and exits the program.

Those skilled in the art will appreciate that the present invention is particularly suited to take advantage of aspects of the invention(s) disclosed in U.S. patent application Ser. No. 10/367,082, the contents of which are incorporated by reference herein, wherein a system and method is disclosed for: generating a student's customized lesson plan for attending distance learning courses; establishing communications between and among instructors and students during their attendance of course classes, during recesses, and after scheduled classes; and ensuring the identity of a student during distance testing on subject matter garnered from a course or during any communication between a counselor and a student during or after a scheduled class.

Those of ordinary skill in the art will also appreciate that an embodiment of the present invention may be used in conjunction with various types of communications systems. For example, the present invention may take advantage of the communications system provided by The Partnership for Academic and Community Excellence (“PACE system”). the PACE system is a school-to-parent communications network built exclusively for the K-12 education market. It allows K-12 school principles to record, distribute, and track a single personalized message to thousands of students' parents. The system may be used for informing parents of holidays, student reports, parent meetings, special events, and fundraisers. The present invention may take advantage of such communications systems. For example, a school may develop a personalized summary of a students progress over a semester and transmit the information to the student's parents prior to an upcoming parent meeting. Advantageously, the parents are fully informed of their child's progress during the past semester bore attending the parents meeting.

Although the present invention has been described in detail with respect to certain embodiments and examples, variations and modifications exist which are within the scope of the present invention as defined in the following claims.

1-31. (Canceled)

32. An individualized learning method, comprising:
storing at least one document in a storage medium of a device;
displaying the at least one document;
generating at least one modification to the at least one displayed document created by a user of the device, wherein the at least one modification is displayed to the user as an integral part of the at least one document;
storing the at least one modification separate from the at least one document in the storage medium so that the at least one modification can be separately categorized, searched, or retrieved; and
correlating the at least one document and the at least one modification.

33. The individualized learning method of claim 32, further comprising categorizing the at least one document in:
an automatic mode where the at least one document is automatically categorized; or
a manual mode where data is received from a user that identifies a category with which the at least one document is correlated.

34. The individualized learning method of claim 32, further comprising categorizing the at least one modification in:
an automatic mode where the at least one modification is automatically categorized; or
a manual mode where data is received from a user that identifies a category with which the at least one modification is correlated.

35. The individualized learning method of claim 32, wherein the storage medium includes a plurality of documents and a plurality of modifications stored thereon.

36. The individualized learning method of claim 32, further comprising generating a personalized summary of an experience based on categorization of the at least one modification made to the documents.

37. The individualized learning method of claim 32, further comprising accessing at least one resource.

38. The individualized learning method of claim 32, further comprising receiving a series of modifications, wherein the series of modifications are made by a third party.

39. The individualized learning method of claim 32, further comprising generating a personalized summary of at least one educational experience.

40. The individualized learning method of claim 32, further comprising transforming the at least one document from one form to another form.

41. The individualized learning method of claim 32, further comprising translating the at least one document from a first language into a second language.

42. The individualized learning method of claim 32, further comprising generating at least one outline of the at least one document based on the at least one modification made to the document.

43. The individualized learning method of claim 32, further comprising generating a review of the at least one document based on the at least one modification.

44. An individualized learning system, comprising:
a storage medium which stores at least one document in a storage medium of a device;
a display which displays the at least one document;
an input device which generates at least one modification to the at least one displayed document created by a user of the device, wherein the at least one modification is displayed to the user as an integral part of the at least one document;
a storage medium which stores the at least one modification separate from the at least one document in the storage medium so that the at least one modification can be separately categorized, searched, or retrieved; and
a processor which correlates the at least one document and the at least one modification.

45. The individualized learning system of claim 44, further comprising categorizing the at least one document in:
an automatic mode where the at least one document is automatically categorized; or
a manual mode where data is received from a user that identifies a category with which the at least one document is correlated.

46. The individualized learning system of claim 44, further comprising categorizing the at least one modification in:
an automatic mode where the at least one modification is automatically categorized; or
a manual mode where data is received from a user that identifies a category with which the at least one modification is correlated.

47. The individualized learning system of claim 44, wherein the storage medium includes a plurality of documents and a plurality of modifications stored thereon.

48. The individualized learning system of claim 44, further comprising generating a personalized summary of an experience based on categorization of the at least one modification made to the documents.

49. The individualized learning system of claim 44, further comprising accessing at least one resource.

50. The individualized learning system of claim 44, further comprising receiving a series of modifications, wherein the series of modifications are made by a third party.

51. The individualized learning system of claim 44, further comprising generating a personalized summary of at least one educational experience.

52. The individualized learning system of claim 44, further comprising transforming the at least one document from one form to another form.

53. The individualized learning system of claim 44, further comprising translating the at least one document from a first language into a second language.

54. The individualized learning system of claim 44, further comprising generating at least one outline of the at least one document based on the at least one modification made to the document.

55. The individualized learning system of claim 44, further comprising generating a review of the at least one document based on the at least one modification.
